(19) United States
(12) Patent Application Publication
(10) Pub. No.: US 2025/0363002 A1
(43) Pub. Date: Nov. 27, 2025

(54) SCAN PACING FOR SCHEDULING OF SCAN OPERATIONS

(71) Applicant: Micron Technology, Inc., Boise, ID (US)

(72) Inventors: Michael William Winterfeld, Firestone, CO (US); John William Slattery, Boulder, CO (US)

(21) Appl. No.: 19/202,884

(22) Filed: May 8, 2025

Related U.S. Application Data
(60) Provisional application No. 63/651,705, filed on May 24, 2024.

(51) Int. Cl. G06F 11/10

(52) U.S. Cl. CPC G06F 11/1048; G06F 11/1068

(57) ABSTRACT

Methods, systems, and devices for scan pacing for scheduling of scan operations are described. A memory system may implement variable timings for performing background scans. In some examples, if the memory system completes a background scan prior to a fixed duration for performing the background scan, the memory system may initiate a timer for the remaining time of the fixed duration. The memory system may then initiate a subsequent background scan based on an expiration of the timer. In some examples, if the memory system does not complete a background scan within the fixed duration, the memory system may track a time deficit corresponding to the difference between the time for completing the background scan and the fixed duration. The memory system may be configured to initiate a subsequent background scan after termination of the previous background scan until the time deficit is eliminated.

### CROSS REFERENCE

The present Application for Patent claims priority to U.S. Patent Application No. 63/651,705 by Winterfeld et al., entitled “SCAN PACING FOR SCHEDULING OF SCAN OPERATIONS,” filed May 24, 2024, which is assigned to the assignee hereof, and which is expressly incorporated by reference in its entirety herein.

### TECHNICAL FIELD

The following relates to one or more systems for memory, including scan pacing for scheduling of scan operations.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports variable timings for background scan operations in accordance with examples as disclosed herein.

FIG. 2 shows an example of a timing diagram that supports variable timings for background scan operations in accordance with examples as disclosed herein.

FIG. 3 shows an example of a timing diagram that supports variable timings for background scan operations in accordance with examples as disclosed herein.

FIG. 4 shows a block diagram of a memory system that supports variable timings for background scan operations in accordance with examples as disclosed herein.

FIGS. 5 and 6 show flowcharts illustrating methods that support variable timings for background scan operations in accordance with examples as disclosed herein.

### DETAILED DESCRIPTION

Some memory systems may perform periodic background scans to detect and correct errors in stored data. In some examples, a memory system may be configured to perform a background scan on each memory device of the memory system over an instance time, with each background scan being performed during a fixed duration within the instance time. In some cases, however, the time to complete a background scan may exceed the fixed duration, especially in memory systems implementing quad-level cells (QLCs), in which background scans may be relatively lengthy. Additionally, or alternatively, the background scans may be delayed due to other operations within the memory system, such as erase, programming, or host read operations, which may delay the background scans. As such, in some cases, the memory system may not be able to perform background scans on each memory device of the memory system within the configured instance time, which may lead to data degradation or loss of data.

In accordance with examples as described herein, a memory system may implement variable timings for performing background scans. In some examples, if the memory system completes a background scan prior to the fixed duration, the memory system may initiate a timer for the remaining time of the fixed duration. The memory system may then initiate a subsequent background scan based on an expiration of the timer. In some examples, if the memory system does not complete a background scan within the fixed duration, the memory system may track a deficit corresponding to the difference between the time for completing the background scan and the fixed duration. The memory system may be configured to initiate a subsequent background scan after termination of the previous background scan until the deficit is accounted for. As such, the memory system may perform background scans for each memory device of the memory system within the configured instance time, thereby improving error correction for the memory system.

In addition to applicability in memory systems as described herein, techniques for supporting variable timings for background scans may be generally implemented to support cloud computing and storage applications. As the use of cloud computing to provide processing, storage, and networking services to multiple devices increases, many devices and systems may benefit from improved remote processing and storage capabilities. For example, increasing memory capacity or other capabilities may result in larger and more accessible storage options for users, and increasing memory access times may result in faster processing for computing or database applications. Implementing the techniques described herein may support cloud computing and storages techniques by improving the longevity of memory systems, thereby supporting the operation of cloud storage devices for longer time periods, and reducing the costs associated with replacement devices, among other benefits.

Features of the disclosure are illustrated and described in the context of systems, devices, and circuits. Features of the disclosure are further illustrated and described in the context of timing diagrams and flowcharts.

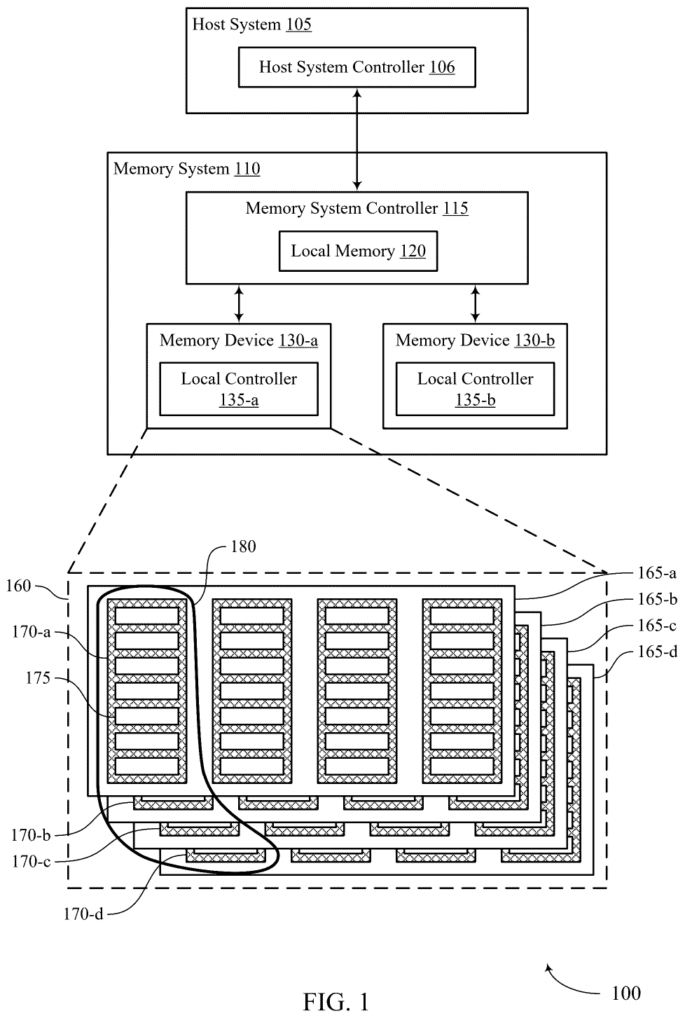

FIG. 1 shows an example of a system 100 that supports variable timings for background scan operations in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (A SIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as QLCs if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In accordance with examples as described herein, a memory system 110 may implement variable timings for performing background scans. In some examples, if the memory system 110 completes a background scan prior to a fixed duration for performing the background scan, the memory system 110 may initiate a timer for the remaining time of the fixed duration. The memory system 110 may then initiate a subsequent background scan based on an expiration of the timer. In some examples, if the memory system 110 does not complete a background scan within the fixed duration, the memory system 110 may track a time deficit corresponding to the difference between the time for completing the background scan and the fixed duration. The memory system 110 may be configured to initiate a subsequent background scan after termination of the previous background scan until the time deficit is accounted for (e.g., eliminated). As such, the memory system 110 may perform background scans for a scan instance within the total time, thereby improving error scanning procedures for the memory system 110.

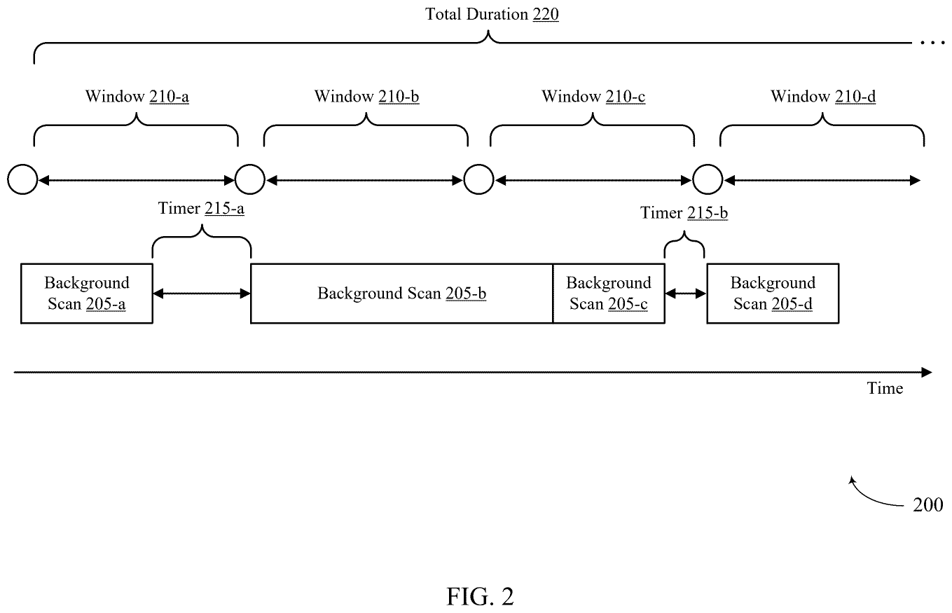

FIG. 2 shows an example of a timing diagram 200 that supports variable timings for background scan operations in accordance with examples as disclosed herein. The timing diagram 200 illustrates the timing for performing background scans 205 by a memory system 110, as described herein with reference to FIG. 1.

In some examples, the memory system 110 may implement error correcting code (ECC) to prevent data loss due to bit errors that may arise at one or more memory cells of the memory devices 130. In some cases, however, the memory system 110 may accumulate bit errors over time which may not be correctable via ECC. As such, the memory system 110 may perform periodic background scans to assess the health of the memory system 110 and in some cases, initiate procedures to detect and correct errors in stored data and re-generate ECC protections. In some examples, the memory system 110 may be configured to perform a scan of all of the memory system 110 (e.g., each memory device 130, each block 170, each plane 165, each memory cell) within a total duration 220 (e.g., Tₜₒₜₐₗ, a scan instance time) for each scan instance. As such, the memory system 110 may be configured to perform a set of periodic background scans 205 over the total duration, and each background scan 205 may correspond to a portion of the data stored at the memory system 110. The memory system 110 may be configured to perform a background scan 205 during a window 210 within the total duration 220, and each window 210 may have a fixed duration scheduled for performing the respective background scan (e.g., T_{scheduled}, Where T_{scheduled}=Tₜₒₜₐₗ/N, where N is the total quantity of background scans).

In some cases, however, the time to complete a background scan may exceed the fixed duration, especially in memory systems 110 implementing quad-level cells (QLCs), in which background scans may be relatively lengthy. For example, as devices implementing QLC techniques may store a large quantity of data per memory cell, the duration of the background scans may be longer. Additionally, or alternatively, the background scans 205 may be delayed due to other operations within the memory system 110, such as erase, programming, or host read operations, which may delay the memory system 110 from performing background scans during the fixed duration. As such, in some cases, the memory system 110 may not be able to perform the background scans 205 within the total time for the scan of the memory system 110, which may lead to data degradation or loss of data.

In accordance with examples as described herein, a memory system 110 (e.g., via one or more controllers, such as the memory system controller 115, one or more local controllers 135-a, or both) may implement variable timings for performing background scans. In some examples, the memory system 110 may perform a background scan 205-a during a window 210-a. The memory system 110 may determine that the background scan 205-a was completed prior to the expiration of the scheduled time (e.g., T_{scheduled}) corresponding to the window 210-a. As such, the memory system 110 may initiate a timer 215-a to a value corresponding to the remaining time in the window 210-a. For example, the memory system 110 may set to value of the timer 215-a to the difference between the time to perform the background scan 210-a operation and the fixed duration scheduled for the window 210-a (e.g., T_{scheduled}−Tₒₚₑᵣₐₜᵢₒₙ) based on the background scan 205-a being performed prior to the end of the window 210-a. The memory system 110 may then initiate a background scan 205-b based on the expiration of the timer 215-a.

In some cases, the background scan 205-b may not be completed within a window 210-b scheduled for performing the background scan 205-b. For example, the background scan 205-b may extend into a window 210-c for performing a background scan 205-c. In these cases, for example, the memory system 110 may initiate the background scan 205-c after (e.g., immediately after, after termination of, triggered by the termination of) the background scan 205-b. Additionally, or alternatively, the memory system 110 may store an indication of a time deficit based on the background scan 205-b exceeding the fixed duration associated with the window 210-b.

In some examples, to determine the time deficit accrued due to background scans 205 not being performed within a respective configured window 210, the memory system 110 may track a quantity of background scans 205 performed during the current scan instance corresponding to the total duration 220, and a total time elapsed in the current scan instance (e.g., as a fraction or subset of the total duration 220). The memory system 110 may calculate the total scheduled time for background scans 205 based on the product of the quantity of background scans performed (e.g., m) and the fixed duration (e.g., m*T_{scheduled}). The memory device may then calculate the deficit as the difference between the total time elapsed and the total scheduled time (e.g., T_{deficit}=T_{elapsed}−m*T_{scheduled}). Additionally, or alternatively, the memory system 110 may calculate the deficit time based on the difference between the time to perform the background scan 205-b and the fixed duration for the window 210-c.

The memory system 110 may perform subsequent background scans 205 after (e.g., immediately after, on termination of) a previous background scan 205 based on the deficit time satisfying a threshold (e.g., the deficit time being greater than zero or another value). For example, the memory system 110 may perform the background scan 205-c after termination of the background scan 205-b.

The memory system 110 may update the deficit time based on performing the background scan 205-c. For example, the memory system 110 may calculate the deficit time after termination of the background scan 205-c. The memory system 110 may determine that the deficit time no longer satisfies the threshold value (e.g., the deficit is less than or equal to zero or another value), and the memory system 110 may refrain from performing a background scan 205-d (e.g., immediately) after termination of the background scan 205-c. For example, the memory system 110 may initiate a timer 215-b with a value corresponding to the difference between the time to perform the background scan 210-c operation and the fixed duration scheduled for the window 210-c (e.g., T_{scheduled}−Tₒₚₑᵣₐₜᵢₒₙ) based on the background scan 205-c being performed prior to the end of the window 210-c (e.g., or based on the deficit time not satisfying the threshold). As such, the memory system 110 may initiate a background scan 205-d after expiration of the timer 215-b (e.g., corresponding to the start of the window 210-d).

By using the techniques described herein, the memory system 110 may improve the performance of background scans in cases where the fixed duration for a window 210 is similar to (e.g., on the order of) the granularity of an operating system timer of the memory system 110. For example, the operating system timer may have a relatively coarse granularity or have a relatively large uncertainty, which may to delays in the pacing of background scans 205. By implementing timers 215 and time deficit tracking, the memory system 110 may account for the uncertainty and granularity of the operating system tracker, as the deficit time may be of a larger magnitude and therefore more accurate even when computed using the operating system tracker, leading to more accurate scheduling of background scans 205.

Accordingly, the memory system 110 may perform background scans 205 with timings based on whether previous background scans 205 completed within fixed duration. As such, the memory system 110 may increase the rate at which background scans 205 are performed when a time deficit exists, while maintaining a current rate if background scans 205 are being performed according to scheduled windows 210. Thereby, error scanning procedures for the memory system 110 may be improved, which may lead to increased longevity of the memory system 110.

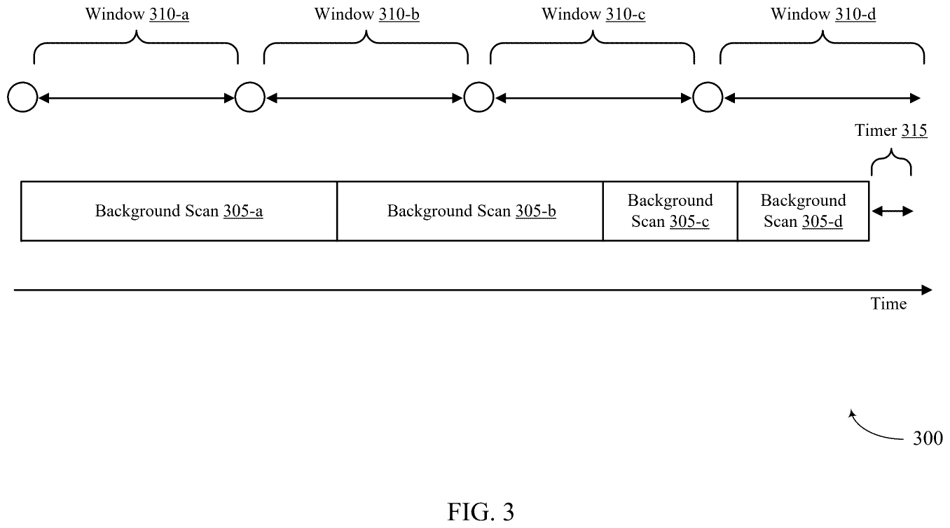

FIG. 3 shows an example of a timing diagram 300 that supports variable timings for background scan operations in accordance with examples as disclosed herein. The timing diagram 300 illustrates the timing for performing background scans 305 by a memory system 110, as described herein with reference to FIGS. 1 and 2. The timing diagram 300 illustrates an example relating to updating a time deficit for performing the background scans 305.

In some examples, the memory system 110 may store an indication (e.g., or otherwise keep track of) a time deficit associated with performing background scans 305, as described herein with reference to FIG. 2. For example, the memory system 110 may perform a background scan 305-a, and the background scan 305-a may exceed a fixed duration corresponding to a window 310-a for performing the background scan 305-a. As such, the memory system 110 may update a time deficit value based on performing the background scan 305-a. For example, the value of the time deficit may be updated based on a difference between a total elapsed time and the total scheduled time for all background scans (e.g., T_{deficit}=T_{elapsed}−m*T_{scheduled}, Where m corresponds to a quantity of background scans), as described herein.

The memory system 110 may initiate the background scan 305-b after (e.g., immediately after) termination of the background scan 305-a based on the value of the time deficit satisfying a threshold value (e.g., the time deficit exists, is greater than zero or another value). In some cases, the background scan 305-b may also exceed the fixed duration corresponding to a window 310-b scheduled for performing the background scan 305-b. The memory system may update the value of the time deficit based on performing the background scan 305-b (e.g., by computing T_{elapsed}−m*T_{scheduled} with updated values).

The memory system 110 may determine that the time deficit still satisfies the threshold value, and the memory system 110 may continue to trigger background scans 305 after termination of previous background scans 305. For example, the memory system 110 may initiate the background scan 305-c after termination of the background scan 305-b. In some examples, the background scan 305-c may be performed in less time than the fixed duration corresponding to a window 310-c for performing the background scan 305-c. However, the time deficit may still exist after updating the value of the time deficit (e.g., by computing T_{elapsed}−m*T_{scheduled} with updated values). As such, the memory system 110 may reduce the value of the time deficit. based on performing the background scan 305-c.

The time deficit may still satisfy the threshold value, and the memory system 110 may continue to trigger background scans 305 after termination of previous background scans 305. For example, the memory system 110 may initiate the background scan 305-d after termination of the background scan 305-c. The memory system 110 may calculate the time deficit after termination of the background scan 305-d, and the memory system 110 may determine that the time deficit is no longer present (e.g., based on computing a value equal to or less than zero). In some examples, the memory system 110 may stop storing the deficit value based on the deficit value being below or equal to zero.

In some examples, the memory system 110 may determine that the time deficit does not satisfy the threshold value. As such, the memory system 110 may initiate a timer 315 based on the time deficit not satisfying the threshold value. The timer 315 may have a value corresponding to the difference between the total elapsed time and the total scheduled time for all background scans (e.g., T_{deficit}=m*T_{scheduled}−T_{elapsed}, Where m corresponds to a quantity of background scans). For example, the timer 315 may correspond to the negation of the value of the time deficit. As such, a subsequent background scan 305 may be initiated after the end of the window 310-d (e.g., at the start of a subsequent window 310).

Accordingly, the memory system 110 may support timings for performing background scans 305 even if multiple background scans 305 exceed the fixed duration by calculating a time deficit associated with the background scans 305.

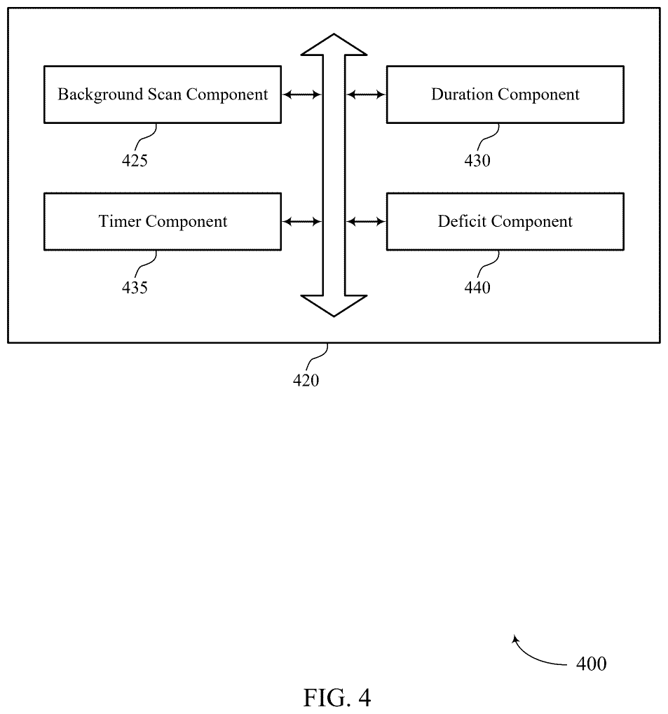

FIG. 4 shows a block diagram 400 of a memory system 420 that supports variable timings for background scan operations in accordance with examples as disclosed herein. The memory system 420 may be an example of aspects of a memory system as described with reference to FIGS. 1 through 3. The memory system 420, or various components thereof, may be an example of means for performing various aspects of scan pacing for scheduling of scan operations as described herein. For example, the memory system 420 may include a background scan component 425, a duration component 430, a timer component 435, a deficit component 440, or any combination thereof. Each of these components, or components of subcomponents thereof (e.g., one or more processors, one or more memories), may communicate, directly or indirectly, with one another (e.g., via one or more buses).

The background scan component 425 may be configured as or otherwise support a means for initiating a first background scan of a first plurality of memory cells of the memory system at a first start time of a first scheduled window for performing one background scan of a plurality of background scans, the first window having a fixed duration. The duration component 430 may be configured as or otherwise support a means for determining whether a first duration to perform the first background scan is greater than or less than the fixed duration. In some examples, the background scan component 425 may be configured as or otherwise support a means for initiating a second background scan for a second plurality of memory cells of the memory system after determining whether the first duration is greater than or less than the fixed duration.

Additionally, or alternatively, the background scan component 425 may be configured as or otherwise support a means for initiating, at a first start time, a first background scan of a first plurality of memory cells of the memory system, the first start time associated with a first scheduled window having a fixed duration that is based at least in part on a time for performing a plurality of background scans. In some examples, the background scan component 425 may be configured as or otherwise support a means for initiating, at a second start time after the first scheduled window, a second background scan for a second plurality of memory cells of the memory system, where the second start time is associated with expiration of a timer or completion of the first background scan based at least in part on whether a first duration for performing the first background scan is greater than or less than the fixed duration.

In some examples, the timer component 435 may be configured as or otherwise support a means for initiating a timer based at least in part on determining that the first duration is less than the fixed duration, a value of the timer being based at least in part on a difference between the fixed duration and the first duration, where the second background scan is initiated after the timer expires.

In some examples, the timer component 435 may be configured as or otherwise support a means for determining that the timer expires, where the second background scan is initiated after the timer expires. In some examples, the second background scan is initiated at a second start time of a second scheduled window that occurs after the timer expires, the second scheduled window having the fixed duration.

In some examples, the timer component 435 may be configured as or otherwise support a means for initiating the timer based at least in part on determining that the first duration is less than the fixed duration, a value of the timer being based at least in part on a difference between the fixed duration and the first duration, where the second start time is after the timer expires. In some examples, the timer component 435 may be configured as or otherwise support a means for determining that the timer expires, where the second background scan is initiated after the timer expires. In some examples, the second start time is associated with a second scheduled window that occurs after the first scheduled window, the second scheduled window having the fixed duration.

In some examples, to support determining whether the first duration is greater than or less than the fixed duration, the deficit component 440 may be configured as or otherwise support a means for determining that the first duration is greater than the fixed duration, where the second background scan is initiated after the first background scan is complete based at least in part on determining that the first duration is greater than the fixed duration.

In some examples, the deficit component 440 may be configured as or otherwise support a means for incrementing a deficit value based at least in part on determining that the first duration is greater than the fixed duration, where the second background scan is initiated after the first background scan is complete based at least in part on the deficit value satisfying a threshold.

In some examples, the deficit component 440 may be configured as or otherwise support a means for updating the deficit value based at least in part on a second duration elapsed since the first start time and a quantity of background scans performed since the first start time. In some examples, the updated deficit value includes a difference between the second duration and a third duration, the third duration corresponding to a product of the fixed duration and the quantity of background scans performed since the first start time.

In some examples, to support determining whether the first duration is greater than or less than the fixed duration, the deficit component 440 may be configured as or otherwise support a means for determining that the first duration is greater than the fixed duration, where the second start time is after the first background scan is complete based at least in part on determining that the first duration is greater than the fixed duration.

In some examples, the deficit component 440 may be configured as or otherwise support a means for incrementing a deficit value based at least in part on determining that the first duration is greater than the fixed duration, where the second background scan is initiated after the first background scan is complete based at least in part on the deficit value satisfying a threshold.

In some examples, the background scan component 425 may be configured as or otherwise support a means for initiating a third background scan for a third plurality of memory cells of the memory system after the second background scan is complete based at least in part on the updated deficit value satisfying the threshold. In some examples, updating the deficit value includes decrementing the deficit value based at least in part on determining that the second duration is less than the fixed duration.

In some examples, the background scan component 425 may be configured as or otherwise support a means for initiating a third background scan for a third plurality of memory cells of the memory system at a third start time of a third scheduled window based at least in part on the updated deficit value failing to satisfy the threshold.

In some examples, the background scan component 425 may be configured as or otherwise support a means for initiating a timer based at least in part on determining that the updated deficit value failed to satisfy the threshold, a value of the timer being based at least in part on the updated deficit value, the second duration, or both.

In some examples, the duration component 430 may be configured as or otherwise support a means for determining the scheduled duration for performing background scans based at least in part on a scan instance time for performing background scans of each memory cell of the memory system. In some examples, the first background scan includes scanning the first plurality of memory cells for correctable errors. In some examples, the memory system includes a QLC memory system.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

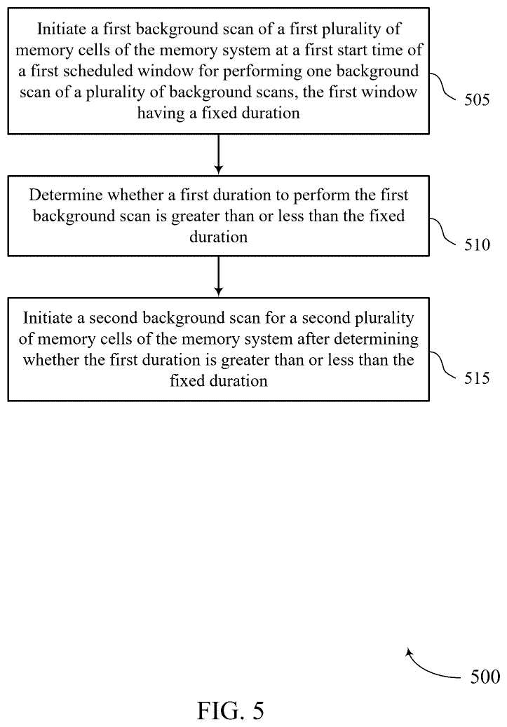

FIG. 5 shows a flowchart illustrating a method 500 that supports variable timings for background scan operations in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include initiating a first background scan of a first plurality of memory cells of the memory system at a first start time of a first scheduled window for performing one background scan of a plurality of background scans, the first window having a fixed duration. In some examples, aspects of the operations of 505 may be performed by a background scan component 425 as described with reference to FIG. 4.

At 510, the method may include determining whether a first duration to perform the first background scan is greater than or less than the fixed duration. In some examples, aspects of the operations of 510 may be performed by a duration component 430 as described with reference to FIG. 4.

At 515, the method may include initiating a second background scan for a second plurality of memory cells of the memory system after determining whether the first duration is greater than or less than the fixed duration. In some examples, aspects of the operations of 515 may be performed by a background scan component 425 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for initiating a first background scan of a first plurality of memory cells of the memory system at a first start time of a first scheduled window for performing one background scan of a plurality of background scans, the first window having a fixed duration; determining whether a first duration to perform the first background scan is greater than or less than the fixed duration; and initiating a second background scan for a second plurality of memory cells of the memory system after determining whether the first duration is greater than or less than the fixed duration.

Aspect 2: The method, apparatus, or non-transitory computer-readable medium of aspect 1, further including operations, features, circuitry, logic, means, or instructions, or any combination thereof for initiating a timer based at least in part on determining that the first duration is less than the fixed duration, a value of the timer being based at least in part on a difference between the fixed duration and the first duration, where the second background scan is initiated after the timer expires.

Aspect 3: The method, apparatus, or non-transitory computer-readable medium of aspect 2, further including operations, features, circuitry, logic, means, or instructions, or any combination thereof for determining that the timer expires, where the second background scan is initiated after the timer expires.

Aspect 4: The method, apparatus, or non-transitory computer-readable medium of any of aspects 2 through 3, where the second background scan is initiated at a second start time of a second scheduled window that occurs after the timer expires, the second scheduled window having the fixed duration.

Aspect 5: The method, apparatus, or non-transitory computer-readable medium of any of aspect 1, where determining whether the first duration is greater than or less than the fixed duration includes operations, features, circuitry, logic, means, or instructions, or any combination thereof for determining that the first duration is greater than the fixed duration, where the second background scan is initiated after the first background scan is complete based at least in part on determining that the first duration is greater than the fixed duration.

Aspect 6: The method, apparatus, or non-transitory computer-readable medium of aspect 5, further including operations, features, circuitry, logic, means, or instructions, or any combination thereof for incrementing a deficit value based at least in part on determining that the first duration is greater than the fixed duration, where the second background scan is initiated after the first background scan is complete based at least in part on the deficit value satisfying a threshold.

Aspect 7: The method, apparatus, or non-transitory computer-readable medium of aspect 6, further including operations, features, circuitry, logic, means, or instructions, or any combination thereof for updating the deficit value based at least in part on a second duration elapsed since the first start time and a quantity of background scans performed since the first start time.

Aspect 8: The method, apparatus, or non-transitory computer-readable medium of aspect 7, where the updated deficit value includes a difference between the second duration and a third duration, the third duration corresponding to the product of the fixed duration and the quantity of background scans performed since the first start time.

Aspect 9: The method, apparatus, or non-transitory computer-readable medium of any of aspects 7 through 8, further including operations, features, circuitry, logic, means, or instructions, or any combination thereof for initiating a third background scan for a third plurality of memory cells of the memory system after the second background scan is complete based at least in part on the updated deficit value satisfying the threshold.

Aspect 10: The method, apparatus, or non-transitory computer-readable medium of aspect 9, where updating the deficit value includes decrementing the deficit value based at least in part on determining that the second duration is less than the fixed duration.

Aspect 11: The method, apparatus, or non-transitory computer-readable medium of any of aspects 7 through 10, further including operations, features, circuitry, logic, means, or instructions, or any combination thereof for initiating a third background scan for a third plurality of memory cells of the memory system at a third start time of a third scheduled window based at least in part on the updated deficit value failing to satisfy the threshold.

Aspect 12: The method, apparatus, or non-transitory computer-readable medium of aspect 11, further including operations, features, circuitry, logic, means, or instructions, or any combination thereof for initiating a timer based at least in part on determining that the updated deficit value failed to satisfy the threshold, a value of the timer being based at least in part on the updated deficit value, the second duration, or both.

Aspect 13: The method, apparatus, or non-transitory computer-readable medium of any of aspects 1 through 12, further including operations, features, circuitry, logic, means, or instructions, or any combination thereof for determining the scheduled duration for performing background scans based at least in part on a scan instance time for performing background scans of each memory cell of the memory system.

Aspect 14: The method, apparatus, or non-transitory computer-readable medium of any of aspects 1 through 13, where the first background scan includes scanning the first plurality of memory cells for correctable errors.

Aspect 15: The method, apparatus, or non-transitory computer-readable medium of any of aspects 1 through 14, where the memory system includes a QLC memory system.

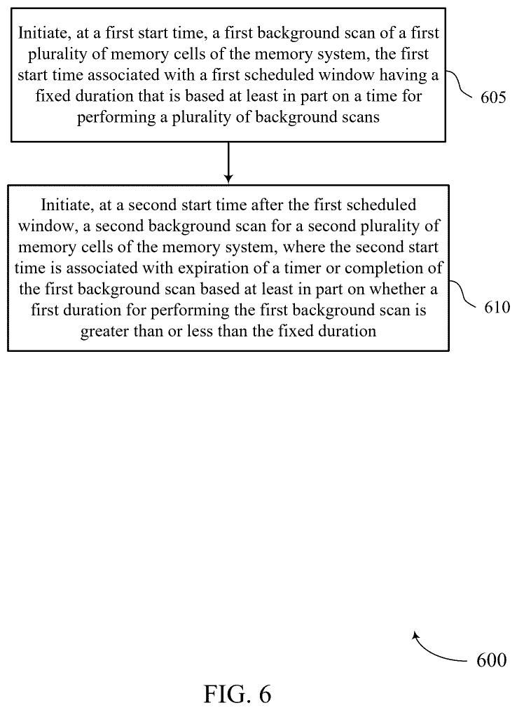

FIG. 6 shows a flowchart illustrating a method 600 that supports scan pacing for consistent scheduling of scan operations in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include initiating, at a first start time, a first background scan of a first plurality of memory cells of the memory system, the first start time associated with a first scheduled window having a fixed duration that is based at least in part on a time for performing a plurality of background scans. In some examples, aspects of the operations of 605 may be performed by a background scan component 425 as described with reference to FIG. 5.

At 610, the method may include initiating, at a second start time after the first scheduled window, a second background scan for a second plurality of memory cells of the memory system, where the second start time is associated with expiration of a timer or completion of the first background scan based at least in part on whether a first duration for performing the first background scan is greater than or less than the fixed duration. In some examples, aspects of the operations of 610 may be performed by a background scan component 425 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 16: A method, apparatus, or non-transitory computer-readable medium including operations, features, circuitry, logic, means, or instructions, or any combination thereof for initiating, at a first start time, a first background scan of a first plurality of memory cells of the memory system, the first start time associated with a first scheduled window having a fixed duration that is based at least in part on a time for performing a plurality of background scans and initiating, at a second start time after the first scheduled window, a second background scan for a second plurality of memory cells of the memory system, where the second start time is associated with expiration of a timer or completion of the first background scan based at least in part on whether a first duration for performing the first background scan is greater than or less than the fixed duration.

Aspect 17: The method, apparatus, or non-transitory computer-readable medium of aspect 16, further including operations, features, circuitry, logic, means, or instructions, or any combination thereof for initiating the timer based at least in part on determining that the first duration is less than the fixed duration, a value of the timer being based at least in part on a difference between the fixed duration and the first duration, where the second start time is after the timer expires.

Aspect 18: The method, apparatus, or non-transitory computer-readable medium of aspect 17, further including operations, features, circuitry, logic, means, or instructions, or any combination thereof for determining that the timer expires, where the second background scan is initiated after the timer expires.

Aspect 19: The method, apparatus, or non-transitory computer-readable medium of any of aspects 17 through 18, where the second start time is associated with a second scheduled window that occurs after the first scheduled window, the second scheduled window having the fixed duration.

Aspect 20: The method, apparatus, or non-transitory computer-readable medium of aspect 16, where determining whether the first duration is greater than or less than the fixed duration includes operations, features, circuitry, logic, means, or instructions, or any combination thereof for determining that the first duration is greater than the fixed duration, where the second start time is after the first background scan is complete based at least in part on determining that the first duration is greater than the fixed duration.

Aspect 21: The method, apparatus, or non-transitory computer-readable medium of aspect 20, further including operations, features, circuitry, logic, means, or instructions, or any combination thereof for incrementing a deficit value based at least in part on determining that the first duration is greater than the fixed duration, where the second background scan is initiated after the first background scan is complete based at least in part on the deficit value satisfying a threshold.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
initiate a first background scan of a first plurality of memory cells of the memory system at a first start time of a first scheduled window for performing one background scan of a plurality of background scans, the first scheduled window having a fixed duration;
determine whether a first duration to perform the first background scan is greater than or less than the fixed duration; and
initiate a second background scan for a second plurality of memory cells of the memory system after determining whether the first duration is greater than or less than the fixed duration.

2. The memory system of claim 1, wherein the processing circuitry is further configured to cause the memory system to:
initiate a timer based at least in part on determining that the first duration is less than the fixed duration, a value of the timer being based at least in part on a difference between the fixed duration and the first duration, wherein the second background scan is initiated after the timer expires.

3. The memory system of claim 2, wherein the processing circuitry is further configured to cause the memory system to:
determine that the timer expires, wherein the second background scan is initiated after the timer expires.

4. The memory system of claim 2, wherein the second background scan is initiated at a second start time of a second scheduled window that occurs after the timer expires, the second scheduled window having the fixed duration.

5. The memory system of claim 1, wherein, to determine whether the first duration is greater than or less than the fixed duration, the processing circuitry is configured to cause the memory system to:
determine that the first duration is greater than the fixed duration, wherein the second background scan is initiated after the first background scan is complete based at least in part on determining that the first duration is greater than the fixed duration.

6. The memory system of claim 5, wherein the processing circuitry is further configured to cause the memory system to:
increment a deficit value based at least in part on determining that the first duration is greater than the fixed duration, wherein the second background scan is initiated after the first background scan is complete based at least in part on the deficit value satisfying a threshold.

7. The memory system of claim 6, wherein the processing circuitry is further configured to cause the memory system to:
update the deficit value based at least in part on a second duration elapsed since the first start time and a quantity of background scans performed since the first start time.

8. The memory system of claim 7, wherein the updated deficit value comprises a difference between the second duration and a third duration, the third duration corresponding to a product of the fixed duration and the quantity of background scans performed since the first start time.

9. The memory system of claim 7, wherein the processing circuitry is further configured to cause the memory system to:
initiate a third background scan for a third plurality of memory cells of the memory system after the second background scan is complete based at least in part on the updated deficit value satisfying the threshold.

10. The memory system of claim 9, wherein, to update the deficit value, the processing circuitry is configured to cause the memory system to:
decrement the deficit value based at least in part on determining that the second duration is less than the fixed duration.

11. The memory system of claim 7, wherein the processing circuitry is further configured to cause the memory system to:
initiate a third background scan for a third plurality of memory cells of the memory system at a third start time of a third scheduled window based at least in part on the updated deficit value failing to satisfy the threshold.

12. The memory system of claim 11, wherein the processing circuitry is further configured to cause the memory system to:
initiate a timer based at least in part on determining that the updated deficit value failed to satisfy the threshold, a value of the timer being based at least in part on the updated deficit value, the second duration, or both.

13. The memory system of claim 1, wherein the processing circuitry is further configured to cause the memory system to:
determine the fixed duration for performing background scans based at least in part on a scan instance time for performing background scans of each memory cell of the memory system.

14. The memory system of claim 1, wherein the first background scan comprises scanning the first plurality of memory cells for correctable errors.

15. The memory system of claim 1, wherein the memory system comprises a quad-level cell (QLC) memory system.

16. A method at a memory system, comprising:
initiating a first background scan of a first plurality of memory cells of the memory system at a first start time of a first scheduled window for performing one background scan of a plurality of background scans, the first scheduled window having a fixed duration;
determining whether a first duration to perform the first background scan is greater than or less than the fixed duration; and
initiating a second background scan for a second plurality of memory cells of the memory system after determining whether the first duration is greater than or less than the fixed duration.

17. The method of claim 16, further comprising:
initiating a timer based at least in part on determining that the first duration is less than the fixed duration, a value of the timer being based at least in part on a difference between the fixed duration and the first duration, wherein the second background scan is initiated after the timer expires.

18. The method of claim 17, further comprising:
determining that the timer expires, wherein the second background scan is initiated after the timer expires.

19. The method of claim 17, wherein the second background scan is initiated at a second start time of a second scheduled window that occurs after the timer expires, the second scheduled window having the fixed duration.

20. A non-transitory computer-readable medium storing code, the code comprising instructions executable by one or more processors to:
initiate a first background scan of a first plurality of memory cells of a memory system at a first start time of a first scheduled window for performing one background scan of a plurality of background scans, the first scheduled window having a fixed duration;
determine whether a first duration to perform the first background scan is greater than or less than the fixed duration; and
initiate a second background scan for a second plurality of memory cells of the memory system after determining whether the first duration is greater than or less than the fixed duration.

21. The non-transitory computer-readable medium of claim 20, wherein the instructions are further executable by the one or more processors to:
initiate a timer based at least in part on determining that the first duration is less than the fixed duration, a value of the timer being based at least in part on a difference between the fixed duration and the first duration, wherein the second background scan is initiated after the timer expires.

22. The non-transitory computer-readable medium of claim 21, wherein the instructions are further executable by the one or more processors to:
determine that the timer expires, wherein the second background scan is initiated after the timer expires.

23. A memory system, comprising:
one or more memory devices; and
processing circuitry coupled with the one or more memory devices and configured to cause the memory system to:
initiate, at a first start time, a first background scan of a first plurality of memory cells of the memory system, the first start time associated with a first scheduled window having a fixed duration that is based at least in part on a time for performing a plurality of background scans; and
initiate, at a second start time after the first scheduled window, a second background scan for a second plurality of memory cells of the memory system, wherein the second start time is associated with expiration of a timer or completion of the first background scan based at least in part on whether a first duration for performing the first background scan is greater than or less than the fixed duration.

24. The memory system of claim 23, wherein the processing circuitry is further configured to cause the memory system to:
initiate the timer based at least in part on determining that the first duration is less than the fixed duration, a value of the timer based at least in part on a difference between the fixed duration and the first duration, wherein the second start time is after the timer expires.

25. The memory system of claim 24, wherein the processing circuitry is further configured to cause the memory system to:
determine that the timer expires, wherein the second background scan is initiated after the timer expires.

26. The memory system of claim 24, wherein the second start time is associated with a second scheduled window that occurs after the first scheduled window, the second scheduled window having the fixed duration.

27. The memory system of claim 23, wherein, to determine whether the first duration is greater than or less than the fixed duration, the processing circuitry is configured to cause the memory system to:
determine that the first duration is greater than the fixed duration, wherein the second start time is after the first background scan is complete based at least in part on determining that the first duration is greater than the fixed duration.

28. The memory system of claim 27, wherein the processing circuitry is further configured to cause the memory system to:
increment a deficit value based at least in part on determining that the first duration is greater than the fixed duration, wherein the second background scan is initiated after the first background scan is complete based at least in part on the deficit value satisfying a threshold.

29. A method at a memory system, comprising:
initiating, at a first start time, a first background scan of a first plurality of memory cells of the memory system, the first start time associated with a first scheduled window having a fixed duration that is based at least in part on a time for performing a plurality of background scans; and
initiating, at a second start time after the first scheduled window, a second background scan for a second plurality of memory cells of the memory system, wherein the second start time is associated with expiration of a timer or completion of the first background scan based at least in part on whether a first duration for performing the first background scan is greater than or less than the fixed duration.

30. The method of claim 29, further comprising:
initiating the timer based at least in part on determining that the first duration is less than the fixed duration, a value of the timer being based at least in part on a difference between the fixed duration and the first duration, wherein the second start time is after the timer expires.
